(19) United States
(12) Patent Application Publication
(10) Pub. No.: US 2013/0079453 A1
(43) Pub. Date: Mar. 28, 2013

(54) PRINTING INK HAVING ENHANCED GLOSS AND LOWER VISCOSITY

(71) Applicants: Daniel C Kraiter, Wilmington, DE (US); Dan Qing Wu, West Chester, PA (US)

(72) Inventors: Daniel C Kraiter, Wilmington, DE (US); Dan Qing Wu, West Chester, PA (US)

(73) Assignee: E I DuPont Nemours and Company, Wilmington, DE (US)

(21) Appl. No.: 13/702,592

(22) PCT Filed: Jun. 28, 2011
(86) PCT No.: PCT/US11/42088

§ 371 Date: Dec. 7, 2012

Related U.S. Application Data
(60) Provisional application No. 61/359,471, filed on Jun. 29, 2010.

(51) Int. Cl. C09D 11/10

(52) U.S. Cl. CPC C09D 11/102; Y10S 977/773; B82Y 30/00
USPC 524/430; 977/773

(57) ABSTRACT

This disclosure relates to ink composition, having a viscosity of 0.02-13 Poise, comprising an inorganic pigment surface treated with alumina and at least one silicon based surface treatment selected from the group consisting of polysiloxane and polysiloxane block polymer to form a treated inorganic pigment, wherein the silicon based surface treatment is present in the amount of about 0.3 to about 1%, based on the total weight of the treated inorganic pigment; a binder resin having a glass transition temperature of less than 50° C., and comprising at least one adhesion promoting group; and a solvent based ink vehicle having the following solubility parameters using the MPa^{1/2} units: σ_{d} of greater than about 15.9, a σₚ of less than about 9.1 and a σₕ of less than about 12.1. These inks have enhanced gloss and lower viscosity characteristics.

### BACKGROUND OF THE DISCLOSURE

This disclosure relates to an ink set for digital and analog printing, in particular to a non-aqueous ink set comprising one or more inks based on certain pigment colorants that provide enhanced gloss. The disclosure also relates to a method of printing with this ink set.

Analog printing methods include the following major processes: letterpress, lithography, gravure, flexography, and screen printing in which ink deposited on a printing plate is transferred by contact to the printing media.

Digital (non-impact) printing processes include inkjet printing in which droplets of ink are deposited on print media, such as paper or polymeric substrates, to form the desired image. The droplets are ejected from a printhead in response to electrical signals generated by a microprocessor.

Inks for printing can comprise a colorant that is dissolved (dye) or dispersed (pigment) in the ink vehicle. The ink vehicle can be aqueous or non-aqueous and the ink is referred to as aqueous or non-aqueous ink, accordingly.

There are many applications where aqueous ink is unsuitable and non-aqueous ink must be used. Many, if not most of these non-aqueous ink

applications, involve printed articles, and particularly printed articles on polymer substrates, which will be exposed to sunlight and the preferred colorants are pigments because of their well-know advantage in fade resistance compared to dyes.

Dispersion of pigment in non-aqueous vehicle is substantially different than dispersion in aqueous vehicle. Generally, pigments that can be easily dispersed in water do not disperse well in non-aqueous solvent, and vice versa. Also, the demands of inkjet printing are quite rigorous and the standards of dispersion quality are high. Thus, pigments that may be “well dispersed” for other applications are often still inadequately dispersed for inkjet applications.

There is a need for improved pigment selection for non-aqueous inks for analog and inkjet applications, more particularly inkjet applications. In particular, there is a need for pigments in non-aqueous inks that provide enhanced gloss.

### SUMMARY OF THE DISCLOSURE

In a first aspect, the disclosure provides an ink composition, having a viscosity of about 0.015 to about 13 Poise, more typically about 0.02 to about 3 Poise, and most typically about 0.02 to about 1.7 Poise comprising:

(a) an inorganic pigment surface treated with alumina and at least one silicon based surface treatment selected from the group consisting of polysiloxane, and polysiloxane block polymer to form a treated inorganic pigment, wherein the silicon based surface treatment is present in the amount of about 0.3 to about 1%, based on the total weight of the treated inorganic pigment;

(b) a binder resin, typically a thermoplastic binder, having a glass transition temperature of less than 50° C. (122° F.), and comprising at least one adhesion promoting group; and

(c) a solvent based ink vehicle having the following solubility parameters using the MPa^{1/2} units: σ_{d} of greater than about 15.9, a σₚ of less than about 9.1 and a σₕ of less than about 12.1.

Optionally, the ink may contain a dispersant, and other additives.

These and other features and advantages of the present disclosure will be more readily understood by those of ordinary skill in the art from a reading of the following detailed description. It is to be appreciated that certain features of the disclosure which are, for clarity, described above and below in the context of separate embodiments, may also be provided in combination in a single embodiment. Conversely, various features of the disclosure which are, for brevity, described in the context of a single embodiment, may also be provided separately or in any sub-combination.

### DETAILED DESCRIPTION OF THE DISCLOSURE

The ink composition of the present disclosure comprises an inorganic pigment, surface treated with alumina and at least one silicon based surface treatment selected from the group consisting of polysiloxane, and polysiloxane block polymer to form a treated inorganic pigment; a thermoplastic binder having a glass transition temperature of less than 50° C. (122° F.), and comprising at least one adhesion promoting group; and a solvent based ink vehicle, typically a non-polar solvent or mixtures thereof, having the following solubility parameters using the MPa^{1/2} units: σ_{d} of greater than about 15.9, a σₚ of less than about 9.1 and a σₕ of less than about 12.1. The ink compositions of this disclosure have a viscosity of about 0.015 to about 13 Poise, more typically about 0.02 to about 3 Poise, and most typically about 0.02 to about 1.7 Poise. These ink compositions have a gloss improvement of 20-40 gloss units when compared to an ink composition not comprising (a), (b), and (c).

### Inorganic Pigment

This disclosure relates to inorganic pigment particles that are primarily titanium dioxide. Other inorganic pigments may be selected from metal oxide, mixed metal oxide, metal hydroxide, metal sulfide, metal carbonate, metal sulfate, silica, and mixtures thereof, wherein the metal is Ca, Mg, Ti, Ba, Zn, Zr, Fe, Mo, Ce or Al, more particularly Ti, Zn or Fe, most particularly Ti.

The TiO₂ may be prepared by any of several well known methods including high temperature vapor phase oxidation of titanium tetrachloride, vapor phase hydrolysis of titanium tetrachloride, hydrolysis of colloidally seeded sulfuric acid solutions of titaniferous raw materials such as ilmenite, and the like. Such processes are well-known in the prior art.

Because the pigment of this disclosure is to be used in applications requiring high gloss, the size of the initial titanium dioxide core particles should not exceed one micron with the average typically falling between about 0.10 and about 0.5 micron, more typically about 0.15 and about 0.5 micron, most typically between about 0.25 and about 0.45 micron as measured by Horiba LA300 Light Scattering Particle Size Distribution Analyzer.

In one embodiment, treatments to be applied by the process of this disclosure to the core particles of titanium dioxide are applied by precipitation in aqueous slurries of the core titanium dioxide particles. The treatment applied to the core particles, in accordance with this disclosure, are either porous or dense. The porous coating comprises alumina and is obtained by precipitating a soluble aluminate in the presence of the core particles. By “soluble aluminate” is meant alkali metal salts of aluminate anions, for example, sodium or potassium aluminate. The soluble aluminates are generally dissolved at a pH of greater than 10 and are precipitated at a pH of less than 10 and typically 7.5 to 9.5. The porous coating can constitute from about 0.5 to about 5% by weight alumina (Al₂O₃), based on the weight of the core titanium dioxide (TiO₂) particles. Less than about 0.5% can cause poor dispersibility of the pigment in paint formulations and an amount of porous coating greater than about 5% can cause significant gloss degradation. Because substantially all of the alumina that is precipitated finds its way onto the core particles, it typically is only necessary to provide that amount of soluble aluminate to the slurry liquid which will result, after precipitation, in the appropriate degree of treatment.

If a dense coating of alumina is preferred, dense coatings can be obtained from a cationic source of alumina. The term “cationic source of alumina” refers to aluminum compounds that dissolve in water to yield an acidic solution. Examples include aluminum sulfate, aluminum chloride, aluminum fluoride, basic aluminum chloride, and the like.

The alumina for the dense coating can be precipitated in the presence of an effective amount of soluble molybdate. While not wanting to be bound to any particular theory, it is believed that the presence of the soluble molybdate while the dense alumina is precipitated enhances the benefits obtained by this disclosure, i.e., an excellent combination of durability and gloss. Applying treatments to the core titanium dioxide particles is described in Baidins et al., U.S. Pat. No. 5,554,216 issued Sep. 10, 1996.

After the layers of dense alumina and/or porous alumina are formed, the resulting coated TiO₂ pigment can be recovered, for example, typically, by washing with water. Because the molybdate is quite soluble, all or essentially all of it can be washed away. Often, after washing, the molybdate will be present in an amount of about 0 to about 3, typically about 0 to about 1.5, and most typically about 0.001-1 percent by weight, calculated as MoO₃ and based on the weight of the TiO₂.

Typically, after precipitation of a dense coating, the slurry is heated to at least about 70° C. and the pH of that slurry is adjusted from about 6 to about 10 to assure complete precipitation of the coating materials.

For the purposes of this disclosure, it should be understood that, by the terms alumina, and Al₂O₃ are meant the hydrous oxides of aluminum. Because of the variable water content of the hydrous oxides, all compositions are calculated based on the anhydrous oxides, although in reality no anhydrous oxides are necessarily present. In fact, all alumina with which this disclosure is concerned is hydrous, that is, it takes the form Al₂O₃.nH₂O. The process of the disclosure related to the treatment with alumina is conducted at about room temperature or perhaps as high as 90° C. after all treatment materials have been added to the slurry.

Alternately, alumina and silica may be added to the TiO₂ particle during oxidation as described in U.S. Pat. No. 5,824,146. The method involves reacting titanium tetrachloride, aluminum chloride and an oxygen-containing gas in the presence of a nucleant in the vapor phase to produce TiO₂ pigment having thereon a treatment of co-ox alumina. A sufficient amount of aluminum chloride is added to produce at least about 0.5 weight %, more typically about 1 weight % of alumina in the TiO₂ pigment.

A similar method involves reacting titanium tetrachloride with “in-situ” generated silicon tetrachloride and an oxygen-containing gas in the presence of a nucleant in the vapor phase to produce TiO₂ pigment having thereon a treatment of co-ox silica as described in U.S. Ser. No. 61/259718 filed Nov. 10, 2009. Alternately, silica can be added using other known techniques such as post-ox as described in U.S. Pat. Nos. 6,852,306 and 7,029,648, Subramanian et. al., or wet treatment. It is recommended that the co-ox silica level be kept low (below about 0.5%, typically about 0.2%) in order to obtain a pigment with high gloss in ink applications based on non-polar solvent ink vehicle comprising having the following solubility parameters using the MPa^{1/2} units: σ_{d} of greater than about 15.9, a σₚ of less than about 9.1 and a σₕ of less than about 12.1.

This TiO₂ pigment may then be separated from the reaction gases, and mixed with sufficient water to produce a TiO₂ slurry comprising at least 30-60% weight %, more typically 35 to 45 weight % TiO₂ solids.

### Silicon Based Treatment:

The alumina treated TiO₂ particles are further treated with a silicon based treatment selected from the group consisting of a polysiloxane and a polysiloxane block polymer. Suitable polysiloxanes have the formula:

R₃SiO—(SiR₂O)ₙ—SiR₃

wherein R is an organic group and n is about 2 to about 6000, typically 2 to about 1000, and more typically 5 to about 500. The organic group is selected from the group consisting of alkyl, aryl or aryl-alkyl groups, typically methyl or ethyl groups.

Some suitable polysiloxanes represented by the above formula include: polydimethylsiloxane (PDMS), vinyl phenyl methyl terminated dimethyl siloxanes divinylmethyl terminated polydimethyl siloxane, and mixtures thereof. Most typically, the polysiloxane is Dow Corning 200R Fluid (Dow Corning, Midland, Mich., USA).

The polysiloxane block polymers useful as treating agents in this disclosure are represented by the formula:

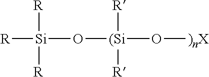

wherein X can be H, OH, CH₃, or a alkylene oxide homopolymer or copolymer having the following formula: —CₙH₂ₙ—OZR″ with n=integer 2-4, Z is ethylene oxide or propylene oxide in block or random fashion and R″ is H, OH or OCH₃, and

R and R′ are independently H, CH₃ or C₂H₅.

Some useful polysiloxane block polymers, more typically polydimethylsiloxane block copolymers include BYK 331, Byk, 310, Byk 307, manufactured by BYK-Chemie GmbH, Wesel, Germany.

Organosiloxanes are commercially available and can be prepared by processes known in the art. See for example, S. Pawlenko, “Organosilicon Compounds”, G. Thieme Verlag, N.Y. (1980).

The silicon based treatment is present in the amount of about 0.3 to about 1%, more typically about 0.3 to about 0.6%, based on the total weight of the treated inorganic oxide particle.

### Binder Resin

The binder resin, typically a thermoplastic polymer, has a glass transition temperature of less than about 50° C., more typically less than about 25° C., and comprises at least one adhesion promoting group. One or more binder resins can be present. Suitable as binder resins are polymers that are soluble or dispersed polymers used to provide the film forming properties, adhesion to substrate and to keep pigment particles well dispersed.

The binder further comprises an adhesion promoting group, By “adhesion promoting group” we mean groups with affinity for the pigment surface. Some suitable adhesion promoting groups include acrylate, methacrylate, urethane, urea, nitrocellulose, olefin, ester, amide, imide, siloxane, vinyl chloride, vinyl acetate or mixtures thereof.

Some suitable binder resins useful in this disclosure include polyesters, polystyrene/(meth)acrylates, poly(meth)acrylates, polyolefins such as polyethylene and polypropylene, polyurethanes, nitrocellulose resin, polyimides, silicone resins, polyamides, polyvinylbutyral; polyvinyl chloride, and polyvinyl chloride/polyvinyl acetate co-polymers and the like. Polystyrene/(meth)acrylates and poly(meth)acrylates having weight average MW's of less than about 100,000 are typical. Specific examples include commercially available products such as Joncryl® from Johnson Polymers LLC. Polyurethane resins (PU) comprised of flexible polyester urethanes/ureas and produced by the reaction of diisocyanates with diols and diamines are also useful. PU resins having weight average MW's about 20,000 to about 50,000 and polydispersity from about 1.8 to about 6 are typical. Some specific examples include resins supplied by Dainippon Ink and Chemicals (Chiba, Japan), Cognis (Cincinnati, Ohio USA) and Reichold (Research Triangle Park, N.C. USA), such as Burnock® 18-472 and Versamid® PUR 1120 and 1010. Polyester resin can be typically formed by the reaction between an polyol and a polycarboxylic acid. Weight average Molecular weight (MW) is between about 1000 and about 10,000 and polydispersity between about 2 and about 5. Aliphatic and/or aromatic diols and dicarboxylic acids are typical. Nitrocellulose resin has spirit or regular solubility and has nitrogen content of about 10 to about 12 wt % and low to moderate viscosity. Specific examples include SS30-35-A-15 available from Bergerac (Bergerac, France). Polyamide resins are commonly derived from dimerized tall oil fatty acids. The typical polyamide resin grades have low gel point, fast recovery, and compatibility with modifiers commonly used in solvent based inks. Polyamide resins having weight average MW's about 5000 to about 30,000 and polydispersity from about 2 to about 5 are typical. Specific examples include Uni-Rez® 2215 available from Arizona Chemicals (Jacksonville Fla., USA) and Versamid® 757 from Cognis.

Polyvinyl chloride/polyvinyl acetate co-polymers are also useful.

When in solution, the binder resin is advantageously used at levels between about 10 and about 21%, based on the total weight of the ink. Upper limits are dictated by ink viscosity, or other physical limitations. The pigment to binder ratio (P/B) ranges between about 1.5 to about 7, more typical about 2.25 and about 5.5 depending on the formulation.

### Solvent Based Ink Vehicle

Solvent-based ink vehicle refers to a vehicle that is substantially comprised of non-aqueous solvent or mixtures of non-aqueous solvents (polar protic, polar aprotic and non-polar), which solvents in this disclosure should typically be predominantly non-polar. The solvent based ink vehicle is an organic solvent or a mixture of organic solvents characterized by solubility parameters based on Hansen solubility parameters (see Charles M. Hansen, I&EC Product Research and Development Vol. 8, No 1 March 1969 and A. F. M. Barton, Chemical Reviews, 1975, Vol. 75, No. 6 pages 731-753):

δ²=δ_{d}²+δₚ²+δₕ²

where δ_{d} is the dispersion component, δₚ is the polar component and δₕ is the hydrogen-bonding component (using the MPa^{1/2} units). For solvent mixtures the solubility parameters were calculated/approximated using a weighted average based on volume fractions (φᵢ) provided that all components have a similar molar volume:

δⱼ=Σᵢφᵢⱼδᵢⱼ

where “j” denotes dispersion (d), polar (p) or hydrogen-bonding (h) component, and “i” denotes each solvent in the solvent mixture.

The solvent based ink vehicle is typically a non-polar solvent or mixtures thereof and has the following solubility parameters using the MPa^{1/2} units: σ_{d} of greater than about 15.9, more typically greater than about 16.0, most typically greater than about 16.4, a σₚ of less than about 9.1 more typically less than about 8.9, most typically less than about 7.0, and a σₕ of less than about 12.1 more typically less than about 8.0, and most typically less than about 6.4. Some examples of non-polar solvents include aliphatic, cycloaliphatic, aromatic hydrocarbons and halogenated derivatives. More typical examples include toluene, xylene, cyclohexane, ketones C2-C5 such as 2-butanone, diethyl ketone, or amyl ketone, chlorobenzene.

The vehicle may also contain polar protic solvents, polar aprotic solvents and other organic solvents provided the vehicle has at least one non-polar solvent and meets the solubility parameters as specified above. Examples of polar protic solvents include alcohols, thiols, amines, cyclic heteroatom-containing (O, N, S) compounds. Specific examples include isopropanol, n-propanol, or n-butanol. Examples of polar aprotic solvents include esters, ethers and heteroatom-containing (O, N, S) compounds. Specific examples include n-propyl acetate, i-propyl acetate.

The amount of solvent-based vehicle in the ink is between about 40 and about 80%, more typically between about 44 and about 60, most typically between about 44 and about 56 wt %, based on the total weight of the ink composition.

The combination of solvent and binder leads to a particularly optimal carrier for TiO₂ pigment.

### Optional Additives For the Titanium Dioxide Containing Inks

The titanium dioxide containing inks, typically ink jet inks, used in the present disclosure may optionally comprise one or more additives. For example, the titanium dioxide containing inks may optionally comprise dispersant, rheology modifier, surfactants, bactericides, fungicides, algicides, sequestering agents, corrosion inhibitors, light stabilizers, anti-curl agents and adjuvants well-known in the relevant art.

Some typical dispersants include Disperbyk® (BYK-Chemie, Wessel Germany), Solsperse® (Lubrizol, Wickliffe, Ohio USA) and EFKA® high molecular weight polymeric dispersants (BASF, Ludwigshafen Germany) suitable for low polarity, solvent based formulations.

The inks may also optionally comprise a rheology modifier. A rheology modifier can be any known commercially available rheology modifiers, such as Solthix® thickeners available from Avecia. Other useful rheology modifiers include cellulose and synthetic hectorite clays. Synthetic hectorite clays are commercially available, for example, from Southern Clay Products, Inc., and include Laponite®; Lucenite SWN®, Laponite S®, Laponite XL®, Laponite RD® and Laponite RDS® brands of synthetic hectorite.

These other ingredients may be formulated into the inks and used in accordance with this disclosure, to the extent that such other ingredients do not interfere with the stability of the ink, and in particular, the jettability of the inkjet ink, which may be readily determined by routine experimentation. The inks may be adapted by these additives to the requirements of a particular printer, for example a flexographic printing device or inkjet printer to provide an appropriate balance of properties such as, for instance, viscosity and surface tension, and/or may be used to improve various properties or functions of the inks as needed.

The amount of each ingredient must be properly determined, but is typically in the range of from about 0 to about 15% by weight, and more typically from about 0.1% to about 10% by weight, based on the total weight of the ink.

Surfactants may be used and some useful examples include ethoxylated acetylene diols (e.g. Surfynols® series from Air Products), ethoxylated primary (e.g. Neodol® series from Shell) and secondary (e.g. Tergitol® series from DowChemical) alcohols, sulfosuccinates (e.g. Aerosol® series from Cytec), organosilicones (e.g. Silwet® series from Witco) and fluoro surfactants (e.g. Zonyl® series from DuPont). Surfactants, if used, are typically in the amount of from about 0.01 to about 5% and typically from about 0.2 to about 2%, based on the total weight of the ink composition.

When the substrates used with the disclosure are porous, such as paper and textiles, binders can be added to reduce the penetration of the ink into the substrates. In other words with these additives, the ink will remain more on the surface of the porous substrate and the opacity hiding power and other printing parameters for the ink will be improved.

### Preparation of Titanium Dioxide Slurry

In one embodiment, the titanium dioxide slurry used in the inks of this disclosure can be prepared by mixing the components in a mixing vessel. Components can be added sequentially or simultaneously in any order. The following provides a typical process to prepare the slurry, but should not be considered limiting. Typically, a two-step process is used involving a first mixing step followed by a second grinding step. The first step comprises mixing all of the ingredients, that is, titanium dioxide pigment, binders, ink vehicle and any optional additives to provide a blended “pre-mix”. Mixing generally occurs in a stirred vessel. High-speed dispersers are particularly suitable for the mixing step. Typically, the binders are combined before introducing into the mixture of other ingredients. The combined binders are typically added incrementally.

The second step comprises grinding of the pre-mix to produce a titanium dioxide slurry. Typically, grinding occurs by media milling, ball milling or shaking on paint shaker in the presence of ceramic or glass beads although other techniques can be used. Following a grinding step, the slurry is filtered. Filtration can be performed using any means known in the art, and is typically accomplished by use of standard, commercially available filters between about 1 and about 10 microns in size. Alternately, filtration may be done after letdown.

After completion of the grinding or dispersing step, additional ink vehicle components (letdown) can be added to prepare the final ink composition. Alternatively, all of the ink components can be added at the mixing step and the dispersing step is done with subsequent dilution.

### Preparation of Inks

The inks of this disclosure are typically made from dry titanium dioxide or slurries thereof as described above, by conventional processes known in the art. That is, the titanium oxide slurry is processed by routine operations to become an ink which can be successfully delivered from an industrial ink delivery system such as flexographic, gravure systems or jetted from an inkjet system.

Typically, in preparing an ink, all ingredients except the pigment slurry are first mixed together. After the other ingredients are mixed, the slurry is added. Common ingredients in ink formulations useful with the titanium dioxide slurries include one or more humectants, a co-solvent, one or more surfactants and biocide.

The titanium dioxide used in this disclosure may utilize a polymeric binder in specific amounts to keep the pigment in suspension and provide the supporting matrix for the film formation. Additionally the formulation may contain dispersant or a mixture of dispersants in specific amounts to stabilize and keep the pigments deflocculated over long periods of time both in slurry form and when the slurry is subsequently used in an ink formulation. As a result, the white ink formulation is stable and non-flocculated or agglomerated and has other advantageous properties when applied to surfaces as an ink.

Alternatively, the ink may be prepared without the intervening step of preparing a pigment slurry. That is, the TiO₂ pigment and other ingredients of the ink can be combined in any order and this mixture is subject to dispersing mixing. The intensity of the mixing can range from milling using a ball mill or more intense dispersive mixing such as HSD, roll milling or media milling can be used to obtain the final ink formulation. There are no constraints on the milling media.

Ink, typically Ink Jet Ink, Properties

Ink delivery and stability are greatly affected by the surface tension and the viscosity of the ink. Ink jet inks typically have a surface tension in the range of about 20 dyne/cm to about 60 dyne/cm at 25° C. The ink compositions of this disclosure have a viscosity of about 0.015 to about 13 Poise, more typically about 0.02 to about 3 Poise, most typically about 0.02 to about 1.7 Poise.

Viscosity of ink jet inks is typically about 0.015 to about 0.15 Poise depending on the type of printhead. The inks have physical properties compatible with a wide range of ejecting conditions, i.e., driving frequency of the piezo element, or ejection conditions for a thermal head, for either a drop-on-demand device or a continuous device, and the shape and size of the nozzle. The inks of this disclosure should have excellent storage stability for long periods so as not clog to a significant extent in an ink jet apparatus. Further, it should not alter the materials of construction of the ink jet printing device it comes in contact with.

Although not restricted to any particular viscosity range or printhead, the inks of the disclosure are suited to lower viscosity applications such as those required by higher resolution (higher dpi) printheads that jet small droplet volumes, e.g. less than about 20 pL. Thus the viscosity (at 25° C.) of the inks of the disclosure can be less than about 8 cps.

Viscosity of analog ink delivery systems such as flexographic or gravure inks vary depending on application, from about 1 to about 3 Poise for solvent based systems to about 7 to about 13 Poise for UV curable (flexo) applications measured at room temperature with a Brookfield-type viscometer.

In an ink system, a well dispersed pigment can lower the ink viscosity and enable the ink maker to reduce thinning solvent to produce an ink of equal final viscosity. The treated pigments of the present invention will allow higher solids ink, thus enabling the printer to reduce wet film thickness and/or increase the surface area covered for a given ink volume at an equal dry film thickness (mileage). An effective pigment treatment will enable the ink maker to also improve gloss by maintaining a good separation between pigment particles during the dispersion (wet) and film forming (drying) stages of the ink preparation and printing process.

The inks of this disclosure are sufficiently stable to be effective ink jet inks. When tested by heating the inks for one week at 70° C. or stored at room temperature for several weeks, the inks should be readily re-dispersible and the physical parameters of particle size and viscosity should be in normal bounds. The inks should also be printable from the desired printing system for multiple days, without any observable decrease in performance.

### Ink Set

Ink sets contain the ink described above and a plurality of other colored inks. The non-white inks of the ink set contain other colorants, such as cyan, magenta, yellow and black, that are described in Roman et al., U.S. Pat. No. 7,041,163.

An additional solid ingredient in the inks of the present disclosure is typically an extender or filler. By definition, extender pigments do not provide opacity, but rather adjust the pigment volume concentration (PVC) and ink properties such as gloss.

Traditionally, pigments are stabilized to dispersion by dispersing agents, such as polymeric dispersants or surfactants. More recently, though, so-called “self-dispersible” or “self-dispersing” pigments (hereafter “SDP(s)”) have been developed. As the name would imply, SDPs are dispersible in a vehicle without dispersants.

A typical black pigment is carbon black. Other pigments for ink jet applications are also generally well known. A representative selection of such pigments is found, for example, in U.S. Pat. No. 5,026,427, U.S. Pat. No. 5,086,698, U.S. Pat. No. 5,141,556, U.S. Pat. No. 5,169,436 and U.S. Pat. No. 6,160,370, the disclosures of which are incorporated by reference herein for all purposes as if fully set forth. The exact choice of pigment will depend upon color reproduction and print quality requirements of the application.

Dispersants to stabilize the additional pigments in the dispersion are typically polymeric because of their efficiency. Examples of typical dispersants for non-aqueous pigment dispersions include, but are not limited to, those sold under the trade names: Disperbyk®, Solsperse® and EFKA® high molecular weight polymeric dispersants suitable for low polarity, solvent based formulations.

Suitable pigments also include SDPs. SDPs for aqueous inks are well known. SDPs for non-aqueous inks are also known and include, for example, those described in U.S. Pat. No. 5,698,016, U.S. 2001003263, U.S. 2001004871 and U.S. 20020056403. The techniques described therein could be applied to the pigments of the present disclosure.

In an ink jet embodiment, it is desirable to use small pigment particles for maximum color strength, opacity and good jetting. The mean particle size may generally be in the range of from about 0.005 micron to about 15 microns, typically in the range of from about 0.005 to about 1 micron, more typically from about 0.05 to about 0.5 micron, and most typically from about 0.1 to about 0.5 micron.

The levels of pigment employed in the instant inks, especially the non-white inks, are those levels that are typically needed to impart the desired optical density (OD) to the printed image. Typically, the non-white pigment levels are in the range of from about 0.01 to about 10% by weight, based on the total weight of the ink.

The ink sets comprising the inks of this disclosure provide significant new breadth to printing capabilities. In one typical embodiment, in addition to the inks of this disclosure, for example a white ink, the ink sets also contain a cyan, magenta and yellow ink. In addition to CMY, it may also be preferred that the ink sets further comprise a black ink.

In another typical embodiment, the ink sets comprise a white ink and a black ink.

### Methods of Printing

In one embodiment, the method of printing comprises a hand-held proofer roller (Pamarco Co., Palmyra N.J. USA), an opaque substrate (black Mylar® or white draw-down card, Leneta Co.) for gloss. The ink was added with a pipette between the anilox and rubber rollers and the proof was made by drawing the proofer down onto the substrate at uniform speed and constant pressure. The proof was allowed to air dry for several hours before gloss readings were made. This process simulates an analog printing method such as flexographic printing.

In another specific embodiment, the method of printing in accordance with the disclosure comprises the steps of:
(i) providing a printer that is responsive to digital data signals typically an ink jet printer;
(ii) loading the printer with a substrate to be printed;
(iii) loading the printer with the above-mentioned inks and/or ink sets;
(iv) printing onto the substrate using the ink set in response to the digital data signals.

When printing on a transparent substrate, like polyethylene terephtalate or polyvinyl butyral, it is sometimes desirable for the image to only appear on one side or be visible from both sides. If the image is to be visible only on one side, the white ink could be printed first and printed in the shape of the image and with adjustable opaqueness such that the image would only appear from one side. The opaqueness can be adjusted by a variety of means including changing the titanium dioxide concentration in the ink, printing multiple times, etc.

If the image is to be seen from both sides then the white ink can be used to provide more flexibility to the image. Its inclusion in parts of the image can improve the whiteness of image areas, and the clarity of the image. Nanograde titanium dioxide with its better transparency may be preferred in this application.

When printing on textiles, the white ink of this disclosure can provide other benefits. Often when textiles are printed the ink will feather into the textile giving an indistinct boundary. The white ink could be use to print a small, imperceptible boundary to a design and making it appear to have a distinct boundary.

The titanium dioxide white ink, since it is stable, can be added to another ink to provide a pigmented ink with both an organic pigment and a titanium dioxide pigment. While a white ink/pigmented ink would be lighter than the pigmented ink, it would retain the covering power and other beneficial properties of a combined ink because of the inclusion of the white ink.

### Printed Substrates

The inks and ink sets can be used to print many substrates including paper, especially colored papers, packaging materials, textiles and polymer substrates. The instant disclosure is particularly advantageous for printing on polymeric (non-porous) substrates of 1 and 30 mil thickness such as polyvinyl butyral interlayer; spun bonded polyolefin (e.g. Tyvek®, DuPont); polyvinyl chloride; polyethylene terephthalate polyester (e.g. Mylar®, DuPont), polyvinyl fluoride polymer, and the like.

Ink-jet printed images using the inks of the present disclosure can be obtained using conventional ink-jet printing equipment, most notably the print head. Print heads suitable for use in the practice of the present disclosure include print heads designed for piezo electric printing, thermal ink jet printing, and continuous drop printing, for example. Printing heads useful for piezo electric printing processes are available from, for example, Epson, Seiko-Epson, Spectra, XAAR and XAAR-Hitachi, and can be suitable for use in the practice of the present disclosure. Printing heads useful for thermal ink jet printing are available from, for example, Hewlett-Packard and Canon and can be suitable for use in the practice of the present disclosure. Printing heads suitable for continuous drop printing are available from Iris and Video Jet, for example and can be suitable for use in the practice of the present disclosure.

### EXAMPLES

### Pigment Treatment P1:

On a flat pan, 2000 g white pigment (TiPure® R-900, DuPont) were sprayed with 150 g of 15% solution of polydimethylsiloxane, PDMS SF18-350 (Momentive Performance Materials, Albany, N.Y.) in ethyl acetate under vigorous mixing to ensure that the pigment surface was covered as uniformly as possible. The wet pigment was allowed to dry for a minimum of 48 hrs. Next, a V-cone blender was used, to break up any chunks of the treated and dried pigment. The blending was performed as follows: V-cone tumble+intensifier bar=10 minutes; V-cone tumble only=5 minutes. The pigment was then micronized on an 8 inch fluid energy mill (micronizer) at a steam-to-pigment ratio of 4 to 1 and an inlet steam temperature of 300° C. Final PDMS content on dry pigment was 0.6 wt %.

### Pigment Treatment P2:

On a flat pan, 2000 g white pigment (TiPure® R-900, DuPont) were sprayed with 40.8 g of 15% solution of BYK 331 (BYK-Chemie, Wesel Germany) in ethyl acetate under vigorous mixing to ensure that the pigment surface was covered as uniformly as possible. The wet pigment was allowed to dry for a minimum of 48 hrs. Next, a V-cone blender was used to break up any chunks of the treated and dried pigment. The blending was performed as follows: V-cone tumble+intensifier bar=10 minutes; V-cone tumble only=5 minutes. The pigment was then micronized on an 8 inch fluid energy mill (micronizer) at a steam-to-pigment ratio of 4 to 1 and an inlet steam temperature of 300° C. Final BYK 331 content on dry pigment was 0.3 wt %.

### Pigment Treatment P3:

Pigment treatment P3 was prepared as described in Pigment treatment P1 with the following exception: the white pigment used was TiPure® R-960 (DuPont, Wilmington, Del.)

### Ink Example 1 (I1):

In a 1 qt friction top can, 120 g of 30% polyester urethane/urea resin (PU) solution (Burnock® 18-472, Dainippon Inks and Chemicals, Inc., Japan), 24 g of methyl ethyl ketone (MEK) and 24 g of toluene (Tol) were added and thoroughly homogenized. To this, 120 g of TiO₂ treated pigment (Pigment Treatment P1) and 440g of 0.2 mm glass beads (grinding media) were added. The container was sealed and placed on a Red Devil paint shaker, off-center, and shook for 45 min. At the end, a mixture of 30 g of toluene and 30 g of MEK was added, and the container was re-sealed and shaken for an additional 10 min. The ink was strained through a disposable 100 mesh screener (Louis M. Gerson Inc., Middleboro, Mass.) to separate the grinding media and the ink was ready to be tested.

### Ink Example 2 (I2)

Ink Example 1 was repeated with the following exception: the pigment used was Pigment Treatment P2.

### Ink Example 3 (I3)

75 g of polyvinyl chloride/polyvinyl acetate (PVC/PVAc, Scientific Polymer Products Inc. Ontario, N.Y. USA) varnish resin solution, 38% in MEK/toluene/cyclohexane mixture (MEK/Tol/C), were weighed in a 1 qt friction top can. A mixture of 10.5 g of toluene and 27 g of MEK was added and thoroughly homogenized. To this, 37.5 g of TiO₂ treated pigment (Pigment Treatment P1) and 150 g of 0.25 mm glass beads (grinding media) were added. The container was sealed and placed on a paint shaker (e.g. Red Devil), off-center, and shaken for 90 min. The ink was strained through a disposable 100 mesh screener (Louis M. Gerson Inc., Middleboro, Mass.) to separate the grinding media and the ink was ready to be tested.

### Comparative Ink Example 1 (C1)

In a 1 qt friction top can, 120 g of 30% PU resin solution (Burnock® 18-472, Dainippon Inks and Chemicals, Inc., Japan), 24 g of MEK and 24 g of toluene were added and thoroughly homogenized. To this, 120 g of TiO₂ pigment (TiPure® R-900, DuPont) and 440 g of 0.2 mm of glass beads (grinding media) were added. The container was sealed and placed on a Red Devil paint shaker, off-center, and shook for 45 min. At the end, a mixture of 30 g of toluene and 30 g of MEK was added, the container was re-sealed and shaken for an additional 10 min. The ink was strained through a disposable 100 mesh screener (Louis M. Gerson Inc., USA) to separate the grinding media and the ink was ready to be tested.

### Comparative Ink Example 2a (C2a)

Comparative Ink Example 1 was repeated with the following exception: the pigment used was TiPure® R-960 (DuPont).

### Comparative Ink Example 2b (C2b)

Comparative Ink Example 1 was repeated with the following exception: the pigment used was Pigment Treatment P3.

### Comparative Ink Example 3 (C3)

Ink Example 3 was repeated with the following exception: the pigment used was TiPure® R-900 (DuPont).

### Testing

The gloss performance can be easily tested by making ink drawdowns on Leneta white card (The Leneta Company, Mahwah, N.J.) or a Mylar® sheet using a 0.006″ clearance Bird applicator or a wire rod (Paul N. Gardner Company, Inc., Fla.).

Gloss was measured at a 60 degree angle (specular reflection) using a BYK-Gardner haze-gloss reflectometer (BYK-Gardner Geretsiried, Germany).

Ink viscosity was measured with Brookfield digital viscometer DV II, provided with #2 spindle at 100 rpm. Alternatively, viscosity was measured using #4 Ford Cup and subsequently converting it to centipoise using published a viscosity conversion chart (A.O.M.-America LLC, Bethlehem, Pa.).

TABLE 1

| | | | | | | | | Ink |
|---|---|---|---|---|---|---|---|---|
| | % | % | Treatment % | | | Solvent | 60-deg | Viscosity |
| Pigment | Al₂O₃ | SiO₂ | Additive | Ink | Resin | (wt ratio) | Gloss | (cPs) |
| TiPure ® | 4.1 | 0.1 | — | C1 | PU | MEK/Tol | 8 | 115 |
| R-900 | | | | | | 50/50 | | |
| Pigment | 4.1 | 0.1 | 0.6% | I1 | PU | MEK/Tol | 32 | 109 |
| Treatment P1 | | | PDMS | | | 50/50 | | |
| Pigment | 4.1 | 0.1 | 0.3% | I2 | PU | MEK/Tol | 10 | 114 |
| Treatment P2 | | | BYK 331 | | | 50/50 | | |
| TiPure ® | 4.1 | 0.1 | — | C3 | PVC/ | MEK/Tol/C | 39 | 220* |
| R-900 | | | | | PVAc | 60/26/14 | | |
| Pigment | 4.1 | 0.1 | 0.6% | I3 | PVC/ | MEK/Tol/C | 68 | 165* |
| Treatment P1 | | | PDMS | | PVAc | 60/26/14 | | |
| TiPure ® | 3.3 | 5.5 | — | C2a | PU | MEK/Tol | 14 | 120 |
| R-960 | | | | | | 50/50 | | |
| Pigment | 3.3 | 5.5 | 0.6% | C2b | PU | MEK/Tol | 5 | 112 |
| Treatment P3 | | | PDMS | | | 50/50 | | |

*centipoise values obtained by converting #4 Ford Cup viscosities

As can be seen in Table 1, the gloss of printed ink is significantly improved when a low silica content pigment is surface treated with the silicon based compounds described above (Pigment treatments P1 and P2). The samples comprising silicon based surface treatment showed low viscosity when compared with samples not comprising the same. The minimal increase in gloss in the case of Pigment Treatment P2 is probably due to the low amount of organic treatment and gloss difference would be expected to be larger if the level of BYK 331 was increased.

Ink viscosity for each pigment treated with the silicon based compounds described above shows a decrease when compared to the untreated pigment, for example by about 2 to about 20%. This may allow the formulation of inks with improved mileage.

Ink Testing Example A Dimatix/Fujifilm testbed (equipped with a Spectra printhead) is loaded with white ink from Table 2 (inventive and comparative examples, respectively).

TABLE 2

| | Ink of this | |
|---|---|---|
| | disclosure | Comparative ink |
| Pigment Type | P1 | TiPure ® R-900 |
| Pigment amount | 50 | 50 |
| Dowanol ® DPM Solvent | 30 | 30 |
| Disperbyk ® 2001 dispersant | 20 | 20 |
| Letdown | 100 | 100 |
| Dowanol ® DPM Solvent | | |

Dowanol ® DPM-dipropylene glycol methyl ether, Dow Chemical Co., Midland, MI
Disperbyk ® 2001-BYK-Chemie, Wesel, Germany

Solvent and dispersant are mixed first, until dispersant is completely dissolved in a 500 mL container. The white pigment is added slowly, to insure good wetting, then 180 g of 0.8-1.0 mm zirconia beads are added. This composition is ground on a paint shaker (Red Devil) for 45 min. Then the rest of the solvent is added in the letdown stage followed by 10 min of additional shaking. The ink is strained through a disposable 100 mesh screener (Louis M. Gerson Inc., USA) to separate the grinding media and the ink is ready to be tested.

Prints are made on Tyvek® JetSmart (DuPont), uncoated polyvinyl chloride, Tedlar® (DuPont) polyethylene terephtalate or Surlyn® (DuPont).

1. An ink composition, having a viscosity of 0.02-13 Poise, comprising:
(a) an inorganic pigment surface treated with alumina and at least one silicon based surface treatment selected from the group consisting of polysiloxane and polysiloxane block polymer to form a treated inorganic pigment, wherein the silicon based surface treatment is present in the amount of about 0.3 to about 1%, based on the total weight of the treated inorganic pigment;
(b) a binder resin having a glass transition temperature of less than 50° C., and comprising at least one adhesion promoting group; and
(c) a solvent based ink vehicle having the following solubility parameters using the MPa^{1/2} units: σ_{d} of greater than about 15.9, a σₚ of less than about 9.1 and a σₕ of less than about 12.1.

2. The ink composition of claim 1 wherein the inorganic pigment is selected from the group consisting of a metal oxide, mixed metal oxide, metal hydroxide, metal sulfide, metal carbonate, metal sulfate, silica, and mixtures thereof, wherein the metal is selected from the group consisting of Ca, Mg, Ti, Ba, Zn, Zr, Fe, Mo, Ce and Al.

3. (canceled)

4. The ink composition of claim 3 wherein the metal is Ti.

5. The ink composition of claim 1 wherein the inorganic oxide has a median particle size of about 0.1 μ to about 0.5μ.

6. (canceled)

7. The ink composition of claim 1 wherein the polysiloxanes have the formula:
R₃SiO—(SiR₂O)ₙ—SiR₃
wherein R is an organic group and n is about 2 to about 6000.

8. The ink composition of claim 1 wherein the polysiloxane represented by the above formula is selected from the group consisting of polydimethylsiloxane (PDMS), vinyl phenyl methyl terminated dimethyl siloxanes divinylmethyl terminated polydimethyl siloxane, and mixtures thereof.

9. The ink composition of claim 1 wherein the polysiloxane is polydimethylsiloxane (PDMS).

10. The ink composition of claim 1 wherein the polysiloxane block polymer is represented by the formula: 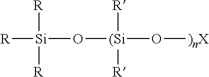
wherein X can be H, OH, CH₃, or a alkylene oxide homopolymer or copolymer having the following formula: —CₙH₂ₙ—OZR″ with n=integer 2-4, Z is ethylene oxide or propylene oxide in block or random fashion and R″ is H, OH or OCH₃, and
R and R′ are independently H, CH₃ or C₂H₅.

11. The ink composition of claim 10 wherein the polysiloxane block polymer is a polydimethylsiloxane block copolymer.

12. The ink composition of claim 1 wherein the silicon based treatment is present in the amount of about 0.3 to about 1.0%, based on the total weight of the treated inorganic oxide particle.

13. The ink composition of claim 1 wherein the binder resin is a thermoplastic binder selected from the group consisting of a polyvinyl chloride/polyvinyl acetate and a flexible polyester urethane/urea.

14. (canceled)

15. (canceled)

16. The ink composition of claim 1 wherein the thermoplastic binder has a weight average molecular weight of about 5,000 to about 100,000 (g/mol).

17. The ink composition of claim 1 wherein the adhesion promoting group is selected from the group consisting of acrylate, methacrylate, urethane, urea, nitrocellulose, olefin, ester, amide, imide, siloxane, vinyl chloride and vinyl acetate and mixtures thereof.

18. (canceled)

19. The ink composition of claim 1 wherein the alumina is present in the amount of about 1 to about 5%, based on the total weight of the treated inorganic pigment.

20. The ink composition of claim 1 wherein the alumina is a precipitated alumina using a wet treatment process wherein the precipitated alumina is selected from the group consisting of crystalline alumina, or amorphous alumina; a co-ox alumina, wherein the TiO₂ pigment is prepared using a chloride process; or combinations thereof.

21. (canceled)

22. The ink composition of claim 1 wherein the solvent based ink vehicle is a non-aqueous solvent or mixture of non-aqueous solvents selected from the group consisting of polar protic, polar aprotic and non-polar, provided at least one non-polar solvent is present.

23. The ink composition of claim 1 wherein the solvent based ink vehicle is predominantly a non-polar solvent.

24. The ink composition of claim 1 wherein the solvent based ink vehicle has solubility parameters using the MPa^{1/2} units: σ_{d} of greater than about 16.0, a σₚ of less than about 8.9, and a σₕ of less than about 8.0.

25. The ink composition of claim 1 wherein the amount of solvent-based vehicle in the ink is present in the amount of about 40 and about 80%, based on the total weight of the ink composition.

26. The ink composition of claim 1 having a viscosity of about 0.02 to about 3 Poise.

27. An ink composition comprising:
(a) an inorganic pigment surface treated with alumina and at least one silicon based surface treatment selected from the group consisting of polysiloxane and polysiloxane block polymer to form a treated inorganic pigment, wherein the silicon based surface treatment is present in the amount of about 0.3 to about 1%, based on the total weight of the treated inorganic pigment;
(b) a binder resin having a glass transition temperature of less than 50° C., and comprising at least one adhesion promoting group; and
(c) a solvent based ink vehicle having the following solubility parameters using the MPa^{1/2} units: σ_{d} of greater than about 15.9, a σₚ of less than about 9.1 and a σₕ of less than about 12.1, wherein the ink composition provides a viscosity reduction of about 2 to about 20% when compared to an ink composition not comprising (a), (b), and (c).

28. The ink composition of claim 27 wherein if silica is present, it is present in the amount of about 0 to about 0.2% of silica, based on the treated inorganic oxide particle.

29. (canceled)

30. (canceled)

31. (canceled)

32. (canceled)

33. (canceled)
